(19) United States
(12) Patent Application Publication
(10) Pub. No.: US 2005/0153590 A1
(43) Pub. Date: Jul. 14, 2005

(54) Fluorescent lamp retaining device

(76) Inventor: Alvin D. McCauley, Holly, MI (US)

Correspondence Address: REISING, ETHINGTON, BARNES, KISSELLE, P.C., P O BOX 4390, TROY, MI, 48099-4390, US

(21) Appl. No.: 11/031,821

(22) Filed: Jan. 7, 2005

Related U.S. Application Data
(60) Provisional application No. 60/535,175, filed on Jan. 8, 2004.
(60) Provisional application No. 60/600,626, filed on Aug. 11, 2004.

(51) Int. Cl. H01R 33/02

(52) U.S. Cl. 439/226

(57) ABSTRACT

A fluorescent lamp retaining device for releasably retaining a fluorescent lamp in a light fixture. The device includes a mount that's supportable on a fluorescent lamp socket of the type that receives and provides electrical contact with a pin pair axially extending from one end of a fluorescent lamp. The mount carries a lamp holder in a position to releasably engage a fluorescent lamp whose pin pair is engaged in the lamp socket that supports the mount. The lamp holder of the lamp retaining device laterally receives one end of a fluorescent lamp as the lamp is being installed and as a pin pair extending from one end of the lamp is being inserted into a fluorescent lamp socket.

### CROSS-REFERENCES TO RELATED APPLICATIONS

This application claims priority from Provisional Application No. 60/535,175, filed Jan. 8, 2004 and entitled FLUORESCENT LAMP RETAINING DEVICE, and Provisional Application No. 60/600,626, filed Aug. 11, 2004 and entitled FLUORESCENT LAMP RETAINING DEVICE.

### STATEMENT REGARDING FEDERALLY SPONSORED RESEARCH OR DEVELOPMENT

Not Applicable

### BACKGROUND OF THE INVENTION

1. Field of the Invention

This invention relates generally to a fluorescent lamp retaining device for releasably retaining a fluorescent lamp in a light fixture.

2. Description of the Related Art Including Information Disclosed Under 37 CFR 1.97 and 1.98

Devices that secondarily retain or support fluorescent lamps in fluorescent lighting fixtures are known in the art. For example, U.S. Pat. No. 2,505,775 issued 2 May, 1950 to Hubbell, discloses a fluorescent lamp retaining device including a fluorescent lamp socket that receives and provides electrical contact with a pin pair axially extending from one end of a fluorescent lamp. A lamp holder in the form of a ring is pivotally supported on the fluorescent lamp socket in a position to releasably engage a ferrule of a fluorescent lamp whose pin pair is engaged in the lamp socket. However, a fluorescent lamp retaining device constructed according to the Hubbell patent is unable to laterally receive a fluorescent lamp into engagement simultaneous with the socket receiving the lamp pins. Instead, the Hubbell retaining device requires separate actuation and engagement. More specifically, according to Hubbell, an installer must first plug one end of a bi-pin fluorescent lamp into the socket, and then swing the retainer ring around its pivot point into engagement with the ferrule of the lamp. To remove a fluorescent lamp, the retainer ring must be rotated and held out of engagement with the lamp before the lamp can then be unplugged from the socket.

In addition, Japanese patent document 2003100402, discloses a pair of opposing spring arms mounted in a lamp fixture midway between a pair of fluorescent lamp sockets in a position to laterally receive a fluorescent lamp as the lamp is being installed in the fixture. To install a fluorescent lamp in the fixture, pin pairs at opposite ends of the lamp are inserted into the sockets. The spring arms are forced apart when a fluorescent lamp is inserted between them and are shaped to releasably retain the lamp once the lamp has been fully inserted between the arms. However, a fluorescent lamp retaining device constructed according to the Japanese '402 document cannot be supported on either of the sockets or installed with a socket as a single piece in the fixture.

Japanese patent document 4-39803 discloses a retainer including a resilient circlip that releasably retains a fluorescent lamp tube at any point along the length of the tube. The retainer also includes a pair of wings, each of which includes clasps shaped to engage opposite edges of a lamp fixture reflector panel so that the retainer is able to support a fluorescent tube from the reflector panel. The retainer is thus designed to more securely support a fluorescent tube in a lamp fixture than a pair of fluorescent tube sockets could do on their own. However, a retainer constructed according to Japanese patent document 4-39803 must be installed in a separate step after a fluorescent lamp has been installed in a lamp fixture between a pair of sockets.

What is needed is a fluorescent lamp retaining device that can laterally and releasably receive a fluorescent lamp into engagement at the same time that a socket receives the lamp pins—and that can do so without requiring separate actuation or engagement of the retaining device. What is also needed is such a fluorescent lamp retaining device that can be supported on either or both of two opposing lamp sockets, or that can be installed in a fluorescent lighting fixture as a single piece combination socket and lamp retaining device.

### BRIEF SUMMARY OF THE INVENTION

A fluorescent lamp retaining device is provided for releasably retaining a fluorescent lamp in a light fixture. The device includes a mount configured to be carried by a fluorescent lamp socket of the type that receives and provides electrical contact with a pin pair axially extending from a fluorescent lamp end. A lamp holder is carried by the mount and is disposed in a position to releasably engage a fluorescent lamp end having an axially-extending pin pair engaged in a lamp socket carrying the mount. The lamp holder is configured to laterally receive such a fluorescent lamp end as the lamp is being installed and as a pin pair axially extending from that lamp end is being received into the lamp socket carrying the mount to support a fluorescent tube in a light fixture more securely than a fluorescent tube socket could do on its own and without requiring separate actuation or engagement of the retainer by engaging the pin pairs at opposite ends of a fluorescent tube.

According to another aspect of the invention, a fluorescent lamp retaining device is provided that comprises a fluorescent lamp socket configured to receive and provide electrical contact with a pin pair axially extending from one end of a fluorescent lamp and a mount carried by the fluorescent lamp socket. A lamp holder is carried by the mount and disposed in a position to releasably engage a fluorescent lamp end having an axially-extending pin pair engaged in the lamp socket. The lamp holder is configured to laterally receive such a lamp end as the lamp is being installed and as the pin pair axially extending from that lamp end is being received into the lamp socket.

The invention also includes a method for releasably retaining a fluorescent lamp in a light fixture. According to this method one can releasably retain a fluorescent lamp in a light fixture by mounting first and second fluorescent lamp retaining devices on respective first and second fluorescent lamp sockets, installing the first and second fluorescent lamp sockets in axially opposite positions in a fluorescent lamp fixture, and then installing a fluorescent lamp in the light fixture by plugging the lamp into the lamp sockets and causing the lamp to engage the first and second fluorescent lamp retaining devices.

### BRIEF DESCRIPTION OF THE SEVERAL VIEWS OF THE DRAWINGS

These and other features and advantages of the invention will become apparent to those skilled in the art in connection with the following detailed description and drawings, in which:

FIG. 1 is front orthogonal view of a fluorescent lamp retaining device constructed according to the invention;

FIG. 2 is a back orthogonal view of the fluorescent lamp retaining device of FIG. 1;

FIG. 3 is a front orthogonal view of the fluorescent lamp retaining device of FIG. 1 carried by a fluorescent lamp socket;

FIG. 4 is a back orthogonal view of the fluorescent lamp retaining device of FIG. 1 carried by a fluorescent lamp socket;

FIG. 5 is front orthogonal view of the fluorescent lamp retaining device of FIG. 1 carried by a fluorescent lamp socket installed in a fluorescent lighting fixture and with a fluorescent lamp installed in the socket and secondarily retained by the lamp retaining device;

FIG. 6 is a front view of the fluorescent lamp socket of FIGS. 3-5;

FIG. 7 is a bottom-front orthogonal view of a fluorescent lamp retaining device constructed according to a second embodiment of the invention and mounted on a fluorescent lamp socket installed in a fluorescent lamp fixture and with a fluorescent lamp plugged into the socket;

FIG. 8 is a bottom-front orthogonal view of the fluorescent lamp retaining device of FIG. 7 mounted on a fluorescent lamp socket and with a fluorescent lamp plugged into the socket;

FIG. 9 is a bottom-front orthogonal view of the fluorescent lamp retaining device of FIG. 7 mounted on a fluorescent lamp socket;

FIG. 10 is a bottom-back orthogonal view of the fluorescent lamp retaining device of FIG. 7 mounted on a fluorescent lamp socket;

FIG. 11 is a top-front orthogonal view of the fluorescent lamp retaining device of FIG. 7;

FIG. 12 is a top-back orthogonal view of the fluorescent lamp retaining device of FIG. 7;

FIG. 13 is a front view of the fluorescent lamp retaining device of FIG. 7;

FIG. 14 is bottom-front orthogonal view a fluorescent lamp retaining device constructed according to a third embodiment of the invention;

FIG. 15 is a bottom-back orthogonal view of the fluorescent lamp retaining device of FIG. 14;

FIG. 16 is a front view of the fluorescent lamp retaining device of FIG. 14;

FIG. 17 is a back view of the fluorescent lamp retaining device of FIG. 14;

FIG. 18 is a top view of the fluorescent lamp retaining device of FIG. 14;

FIG. 19 is a bottom view of the fluorescent lamp retaining device of FIG. 14;

FIG. 20 is a bottom-front orthogonal view of the fluorescent lamp retaining device of FIG. 14 shown axially adjacent a fluorescent lamp socket that the retaining device of FIG. 14 is configured to be supported on;

FIG. 21 is a bottom-front orthogonal view of the fluorescent lamp retaining device of FIG. 14 supported on the socket of FIG. 20;

FIG. 22. is a bottom-front orthogonal view of the fluorescent lamp retaining device of FIG. 14 supported on the socket of FIG. 20 as in FIG. 21 and with a fluorescent lamp plugged into the socket of FIG. 20 and supported by the retaining device of FIG. 14.

### DETAILED DESCRIPTION OF INVENTION EMBODIMENT(S)

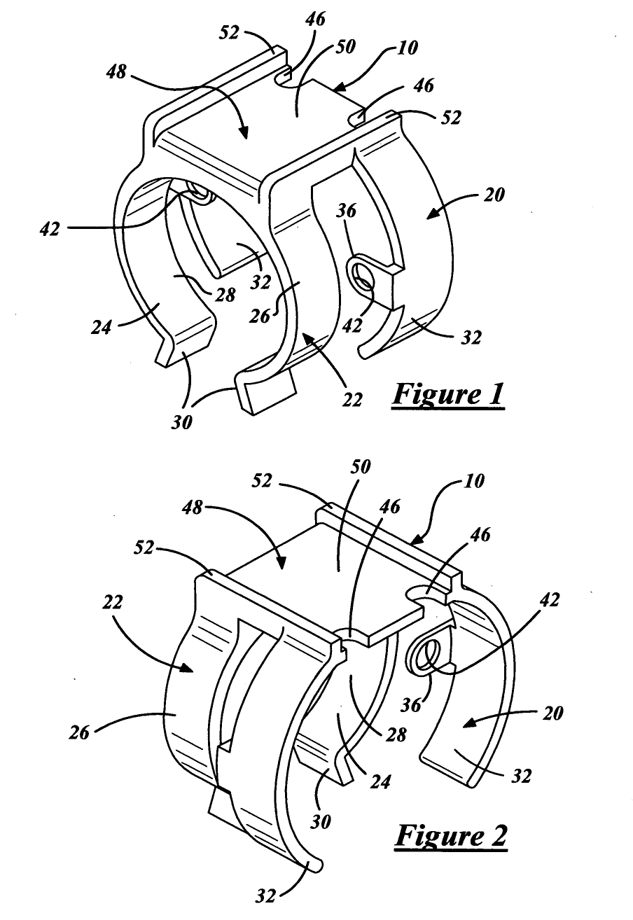

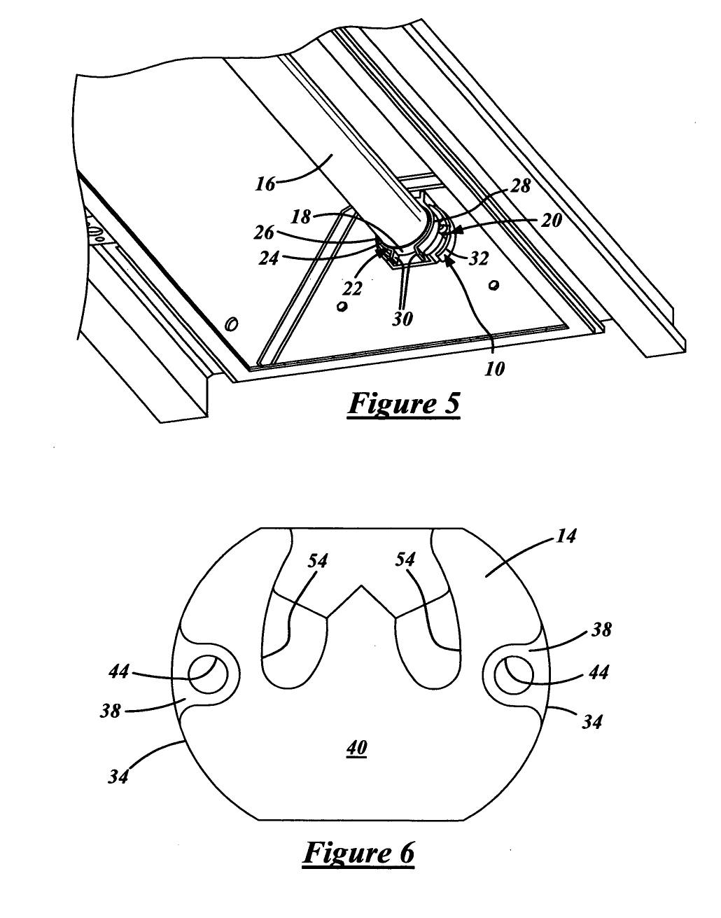

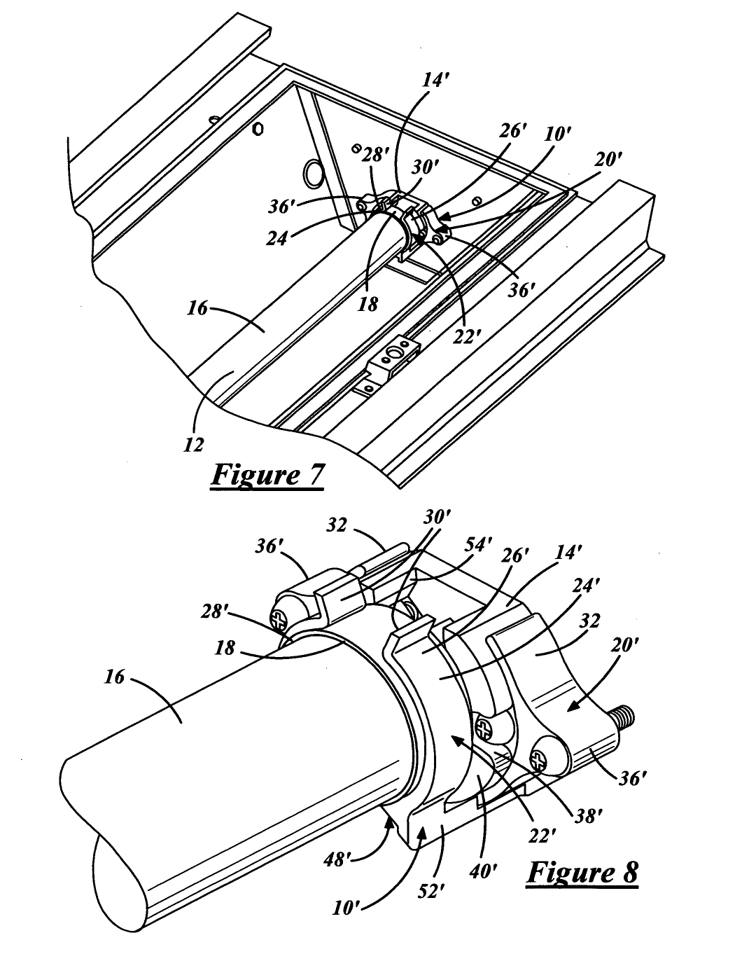

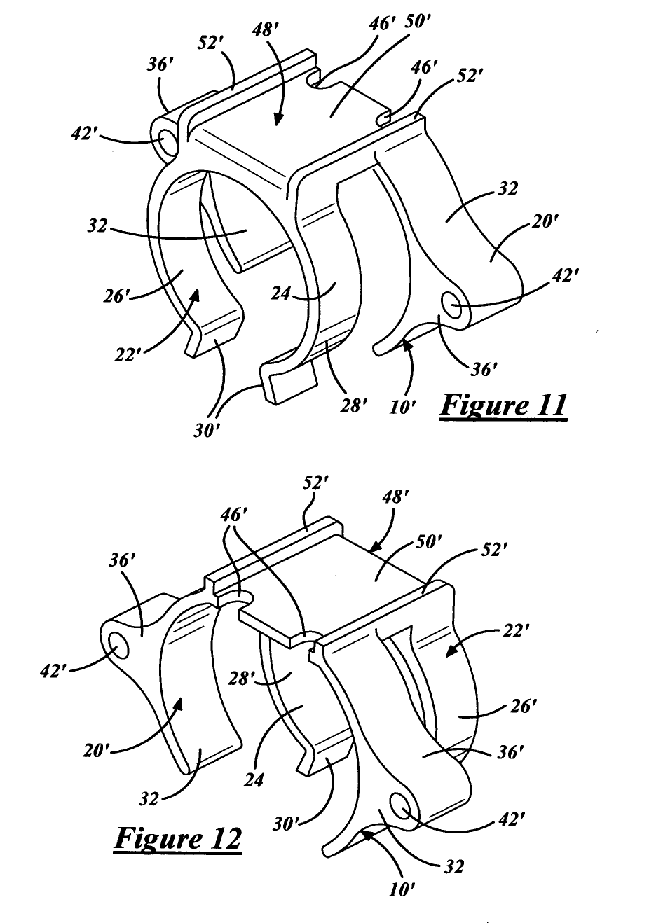

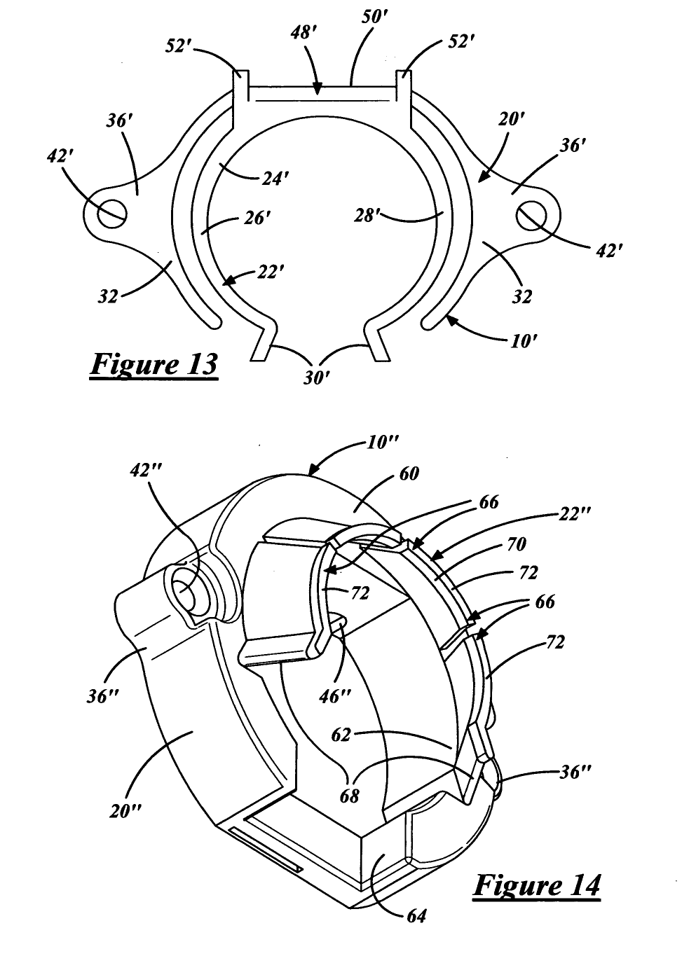

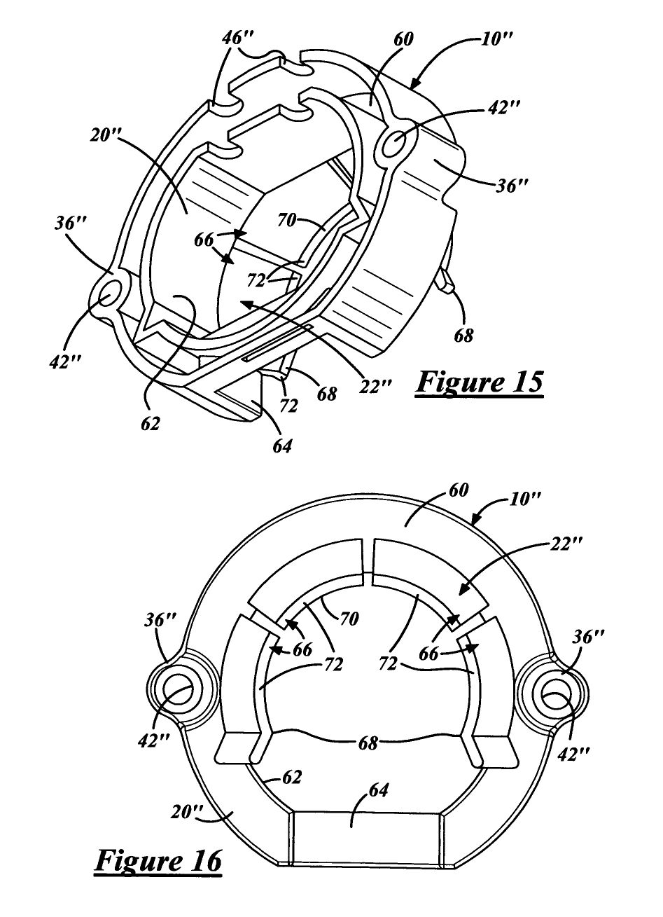

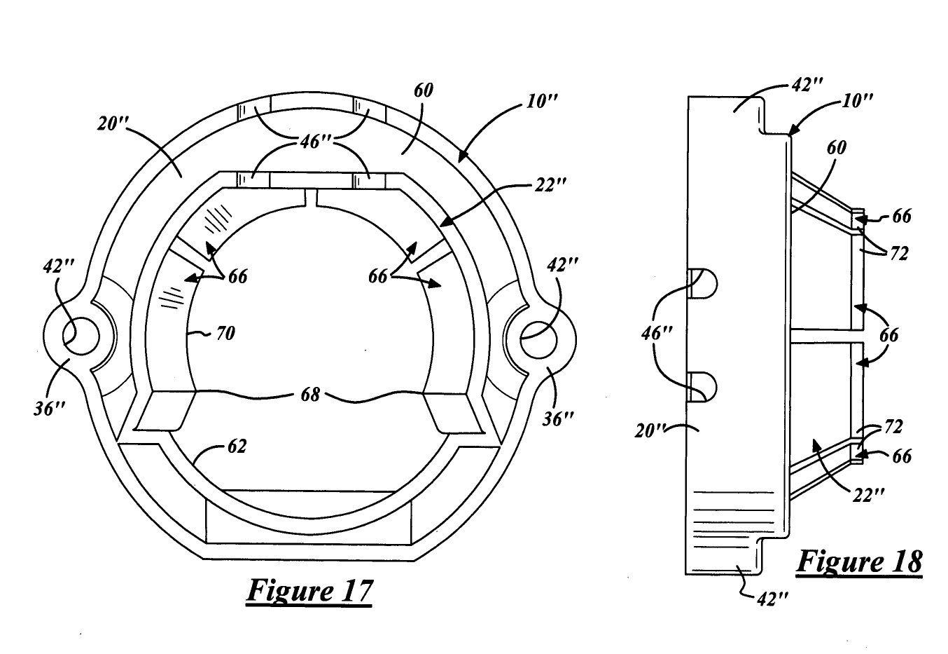

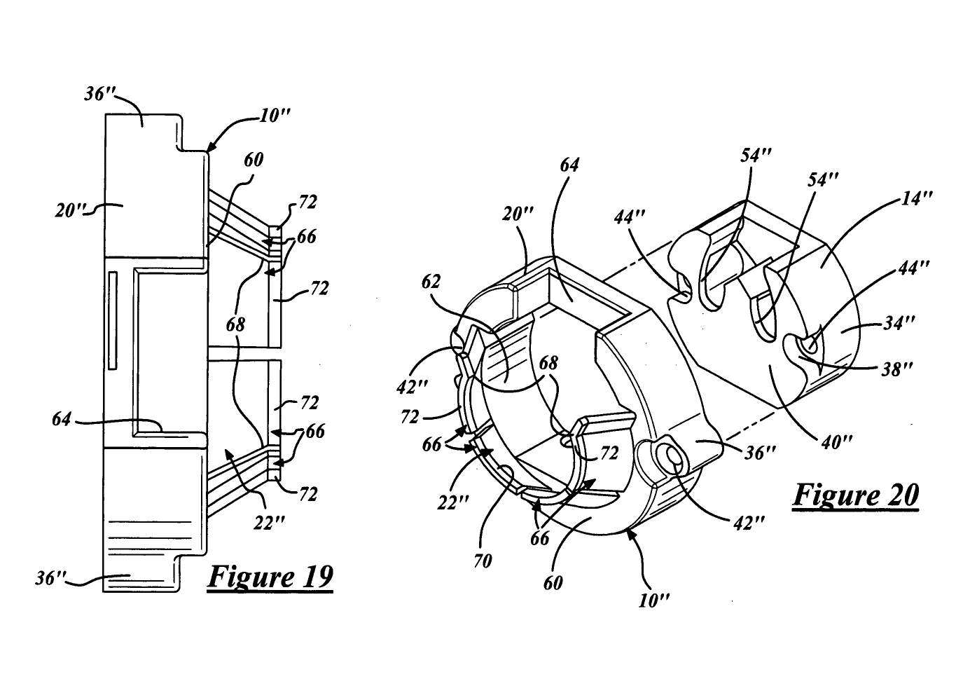

A fluorescent lamp retaining device for releasably retaining a fluorescent lamp in a lamp fixture 12 and constructed according to a first embodiment of the invention is shown at 10 in FIGS. 1-5. A fluorescent lamp retaining device constructed according to a second embodiment of the invention is shown at 10′ in FIGS. 7-13. A fluorescent lamp retaining device constructed according to a third embodiment of the invention is shown at 10″ in FIGS. 14-22. Structures in the second and third embodiments that correspond to the same or similar structures in the first embodiment are identified by the same reference numeral but with respective prime (′) or double-prime (″) annotations. Except where indicated otherwise, the following description refers to the device 10 constructed according to the first embodiment.

Generally, two fluorescent lamp retaining devices 10 are mounted axially opposite one another in a fluorescent lamp fixture 12, with each being carried by one of two axially opposing fluorescent lamp sockets 14. This provides for the support of both ends of a fluorescent lamp 16 of the type that has a pair of electrical contact pins extending from each of two ferrules 18 that close respective opposite ends of the lamp 16. Since the same device 10 is used in both positions only one such device will be described.

The fluorescent lamp retaining device 10 includes a mount 20 supportable on a fluorescent lamp socket 14 of the type that receives and provides electrical contact with a pin pair axially extending from one end of a fluorescent lamp 16. The fluorescent lamp socket 14 shown supporting the fluorescent lamp retaining device 10 in the drawings is commercially available and identifiable as a Kulka 590 series lamp holder. (Although the Kulka 590 is commonly known in the art as a “lamp holder,” this application will refer to it as a “socket 14” to avoid confusion with what the application describes, below, as a “lamp holder” portion of the fluorescent lamp retaining device 10 that is the subject of this application). The lamp holder 22 of the fluorescent lamp retaining device 10 is carried by the mount 20 and disposed in a position to releasably engage a fluorescent lamp 16 whose pin pair is engaged in a lamp socket 14 that supports the mount 20. The lamp holder 22 laterally receives one end of a fluorescent lamp 16 as the lamp 16 is being installed in a fixture 12 and as a pin pair extending from the one end of the lamp 16 is being inserted into a fluorescent lamp socket 14 of the fixture 12. The lamp retaining device 10 supports a fluorescent lamp 16 in a lamp fixture 12 more securely than a fluorescent lamp socket 14 could do on its own.

The lamp holder 22 of the fluorescent lamp retaining device 10 includes a resilient circlip 24 that includes two diametrically opposing circlip ribs 26, 28. The ribs 26, 28 are forced to spread apart when a fluorescent lamp 16 is laterally inserted between them and to spring back toward each other and releasably retain the lamp 16 once the lamp has been fully inserted between them. Lower distal ends of the two circlip ribs 26, 28 are curved radially outward to form respective camming surfaces 30 positioned to smoothly spread the ribs 26, 28 apart when a fluorescent lamp 16 is pushed laterally between the distal ends of the ribs 26, 28.

The lamp holder 22 laterally receives the ferrule 18 of a fluorescent lamp 16 into engagement simultaneous with the socket 14 receiving the lamp pins. The mount 20 of the fluorescent lamp retaining device 10 includes a pair of mounting ribs 32 shaped to engage a fluorescent lamp socket 14 by wrapping around a radially outer sidewall 34 of such a socket 14. As shown in the drawings, the mounting ribs 32 are semi-circular to accommodate a generally cylindrical socket 14 configuration. Each of these semi-circular mounting ribs 32 has an inner radius generally the same as an outer radius of a generally cylindrical fluorescent lamp socket 14 that is to carry the lamp retaining device 10.

The mount 20 includes first and second mounting tabs 36 that extend radially inward from respective first and second ones of the mounting ribs 32 in respective positions where the mounting tabs 36 will engage diametrically opposite fastener head-receiving recesses 38 that are formed into a front face 40 of a fluorescent lamp socket 14 that is to carry the lamp retaining device 10. Each mounting tab 36 includes a tab through-hole 42 positioned to align with a fastener receiving hole 44 of a fluorescent lamp socket 14 that is to carry the lamp retaining device 10. As such, fasteners used to mount the socket 14 to a lamp fixture 12 also serve to secure the lamp retaining device 10 to the socket 14.

The mount 20 also comprises two locating slots 46 formed in a back side of the mount. The locating slots 46 are shaped and positioned to receive a pair of locating ribs formed into a supporting surface of a light fixture 12 that the lamp retaining device 10 is to be supported on.

As shown in FIGS. 7-13, the second embodiment of the fluorescent lamp retaining device 10′ includes first and second mounting tabs 36′ that extend radially outward from respective first and second ones of the mounting ribs 32′ rather than radially inward as do the mounting tabs 36 of the first embodiment. Each mounting tab 36′ includes a tab through-hole 42′ positioned to align with a fastener receiving hole of a fluorescent lamp fixture 12.

The fluorescent lamp retaining device 10 includes a spine 48 that extends integrally and axially forward from an upper mid region of the mount 20. The lamp holder 22 is supported on and integrally extends from a forward distal end of the spine 48. The spine 48 includes a flat, generally rectangular center section 50 bordered by a pair of elongated rectangular axial ribs 52. Both the center section 50 and the axial ribs 52 merge integrally with the mount 20 at an aft end of the spine 48 and with the lamp holder 22 at a forward end of the spine 48. More specifically, the two mount ribs 32 extend integrally and laterally from along respective aft ends of the axial ribs of the spine 48, and the two lamp holder ribs 22, 24 extend integrally and laterally from along respective forward ends of the axial ribs of the spine 48. The spine 48 serves to axially position the lamp holder 22 where it will engage the ferrule 18 of a fluorescent lamp 16 to be supported by the lamp holder 22. The mount 20, spine 48, and lamp holder 22 are formed together as a single, unitary piece.

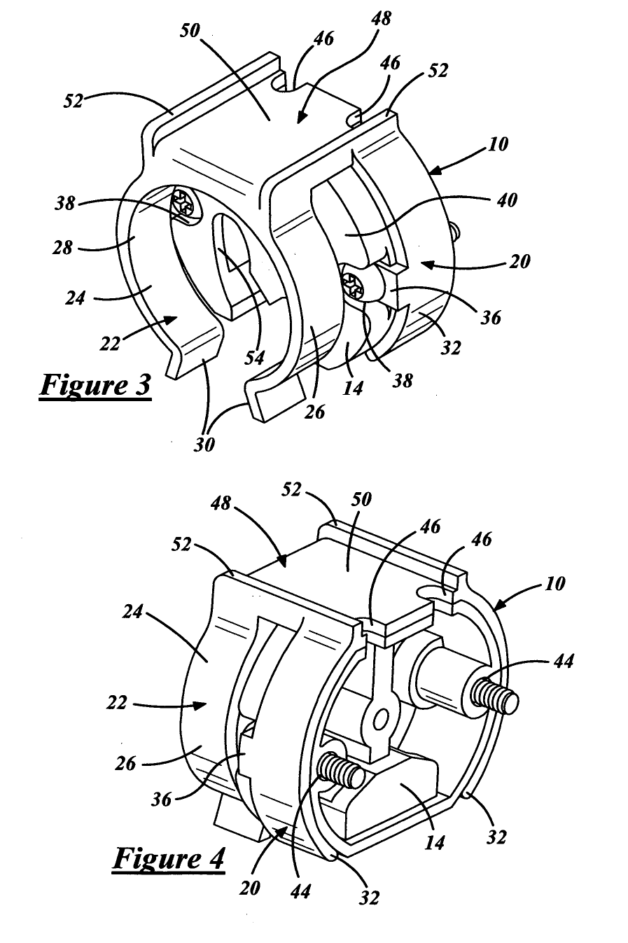

The type of lamp socket 14 that the fluorescent lamp retaining device 10 is preferably carried by is the type configured for “turn-lock” insertion of a bi-pin fluorescent lamp 16, i.e., to receive an axially extending pair of pins of a fluorescent lamp 16 through rotating engagement, e.g., the socket disclosed in U.S. Pat. No. 3,060,400, which issued 23 Oct. 1962 to J. M. Pistey; and also disclosed in U.S. Pat. No. 4,198,109, which issued 15 Apr. 1980 to Ustin. The preferred lamp socket configuration is best shown in FIGS. 3, 4, 6, 8-10, and 20-22 of the drawings.

As best shown in FIG. 6, this preferred lamp socket 14 includes a pair of arcuate slots 54. One of these slots 54 laterally receives one of the pins of an axially-extending pin pair of a fluorescent lamp 16 into engagement with a first electrical contact. The other of the two slots 54 then laterally receives a second pin of the pin pair when the fluorescent lamp 16 is rotated about the first pin such that the second pin travels around an arcuate path through the second of the two slots 54 into engagement with a second electrical contact. The mount 20 of the fluorescent lamp retaining device 10 engages a fluorescent lamp 16 as the first pin is laterally inserted into the first slot of the pair of arcuate slots 54. The mount 20 then flexes as necessary to accommodate the motion of the fluorescent lamp 16 as it is rotated about the first pin and until the second pin is received into the electrical contact of the second arcuate slot.

As shown in FIGS. 14-22, the mount 20″ of the third embodiment of the fluorescent lamp retaining device 10″ includes a support ring 60 supportable axially adjacent a fluorescent lamp socket 14 and including a central, generally cylindrical axial opening 62 shaped accommodate a fluorescent lamp socket 14 and a lower, generally rectangular radial pin channel or gap 64 shaped to allow electrical contact pins of the fluorescent lamp end to be laterally received into the axial opening 62 of the support ring 60 and into a lamp socket 14 carried by the support ring 60. The lamp holder 22 of the third embodiment includes four resilient lamp holder fingers 66 that extend integrally and radially inwardly from around the support ring 60 and forward or axially away from a socket 14 disposed in the support ring 60. The lamp holder fingers 66 are shaped such that the fingers are splayed apart when distal radially inward ends of the fingers are forced apart in respective radially outward directions by a fluorescent lamp 16 being inserted between them. The fingers 66 are also shaped and positioned to releasably retain a fluorescent lamp 16 once the lamp has been fully inserted between the fingers 66.

The lamp holder fingers 66 are disposed in an array that includes a lower lamp-receiving gap 68 between two lower-most fingers. The lower lamp-receiving gap 68 coincides with the lower radial pin channel 64 and, as with the lower radial pin channel, is slightly narrower than a diameter of a fluorescent lamp 16 to be supported. The lower lamp-receiving gap 68 is also slightly narrower than a diameter of a semi-circular finger opening 70 formed by the distal ends of the lamp holder fingers 66. The lamp-receiving gap 68 is shaped to allow a fluorescent lamp 16 to be pushed laterally or radially into the semi-circular axial finger opening 70 from a position radially displaced from the fluorescent lamp retaining device 10, forcing the fingers 66 to splay apart sufficiently to accommodate the lateral or radially inward insertion of a lamp 16.

Each lamp holder finger 66 of the third embodiment has an arcuate, generally trapezoidal prism shape of generally uniform thickness. The base end of each finger is curved to have a radius generally matching that of the central axial opening of the support ring 60. The distal end of each finger 66 is curved to have a radius generally matching that of a fluorescent lamp 16 to be supported. Together, the four arcuate fingers 66 form a semi-frusto-conical shape. The distal end of each lamp holder finger 66 includes an axially-directed lip 72 shaped to increase the area of each finger 66 where it is to contact and hold a supported lamp 16.

The mount 20 of the third embodiment also comprises mounting flanges 36″ that extend radially outward from generally diametrically opposite outer sidewalls 34″ of the support ring 60. The mounting flanges 36″ include respective axial through-holes 42″ shaped to receive fasteners that hold the fluorescent lamp retaining device 10″ to a supporting structure such as a light fixture 12.

In practice, a fluorescent lamp 16 may be releasably retained in a fluorescent lamp fixture 12 by first mounting two fluorescent lamp retainer devices 10 on two fluorescent lamp sockets 14, respectively. To accomplish this the fluorescent lamp sockets 14 are inserted between the mounting ribs 32 of the respective fluorescent lamp retaining devices 10 until the mounting tabs 36 of the fluorescent lamp retaining devices 10 engage the fastener-head receiving recesses 38 of the lamp sockets 14 as shown in FIG. 3.

As best shown in FIGS. 8-10, where fluorescent lamp retaining devices 10′ constructed according to the second embodiment are used, the lamp sockets 14′ are inserted between the mounting ribs 32′ of the respective devices 10′ until back surfaces of each are approximately flush with one another.

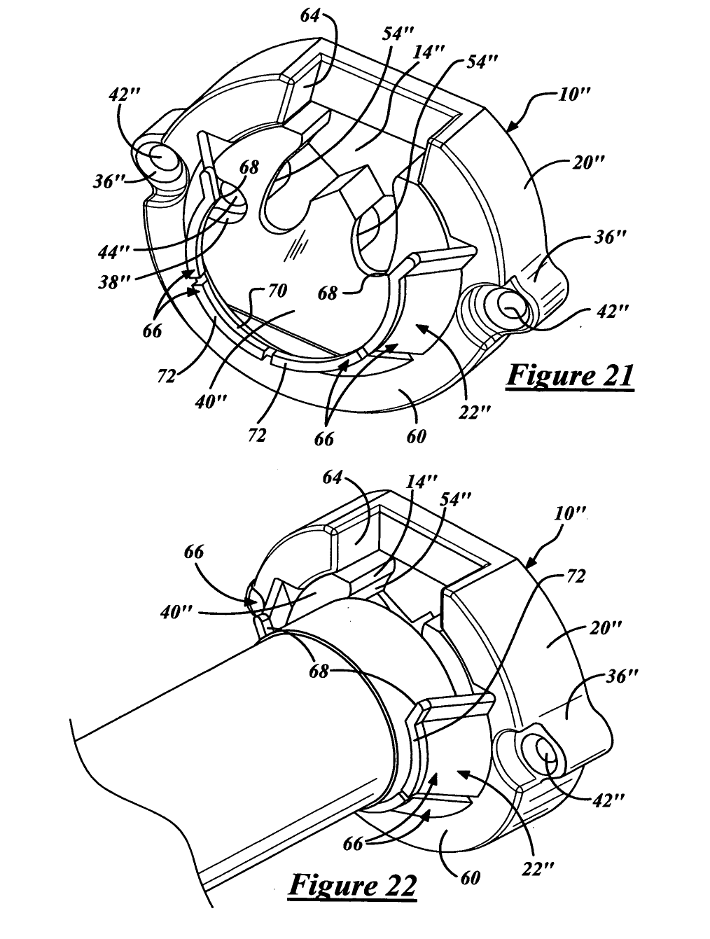

As best shown in FIGS. 20 and 21, where fluorescent lamp retaining devices 10″ constructed according to the third embodiment are used, the lamp sockets 14″ are inserted into the respective cylindrical axial openings 62 of the devices 10″ until back surfaces of each are approximately flush with one another.

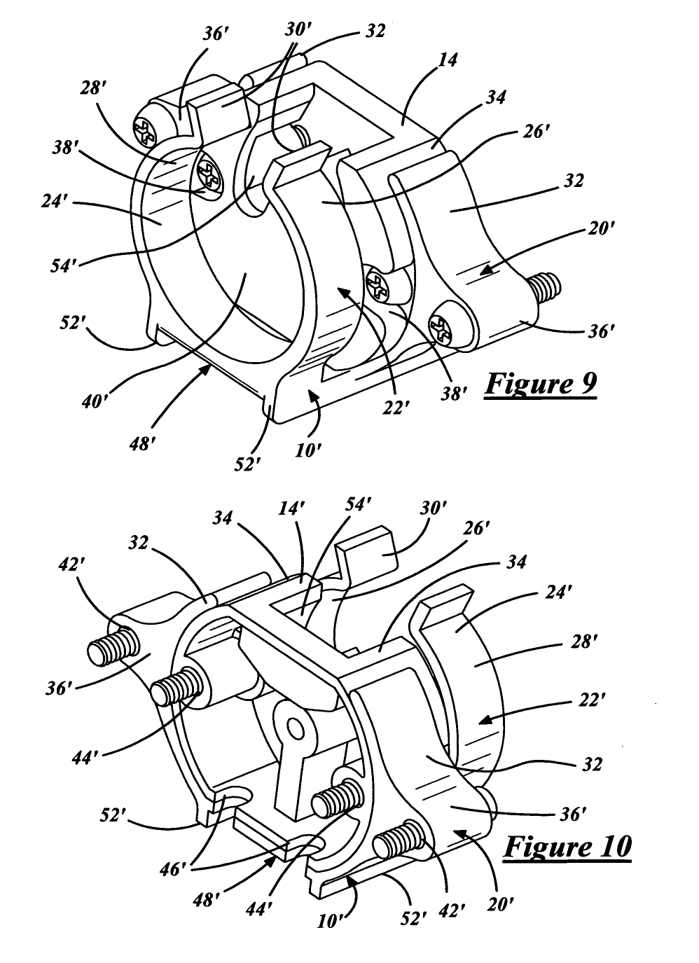

Returning to the first embodiment, the fluorescent lamp sockets 14 are then installed in axially opposite positions in a fluorescent lamp fixture 12. This may include positioning the lamp sockets 14 in the fluorescent lamp fixture 12 such that fastener holes 44 of the sockets 14 align with corresponding fixture fastener holes in the fluorescent lamp fixture 12, then inserting fasteners through the tab fastener holes 42 in the mounting tabs 36 of the fluorescent lamp retaining devices 10, the socket fastener holes 44 of the sockets 14, and the fastener holes of the fluorescent lamp fixture 12 such that the fasteners secure the fluorescent lamp retaining devices 10 to the sockets 14 and the sockets 14 to the fixture 12.

Where fluorescent lamp retaining devices 10′ constructed according to the second embodiment are being installed, as shown in FIGS. 9 and 10; or where devices 10″ constructed according to the third embodiment are being installed, as shown in FIGS. 20 and 21; two additional fasteners must be used. The two additional fasteners are inserted through the holes 42′ in the mounting tabs 36′ and into corresponding holes in a lamp fixture 12.

A fluorescent lamp 16 is then installed in the lamp fixture 12 while causing the ends of the lamp 16 to engage the fluorescent lamp retaining devices 10. This step may include positioning ferrules 18 of the fluorescent lamp 16 against the cam surfaces 30 formed by the out-turned distal ends of the circlip ribs 26, 28 of the fluorescent lamp retaining devices 10; then pushing the ferrules 18 through respective gaps between the distal ends of the circlip ribs 26, 28 of each device 10 such that the circlip ribs 26, 28 are spread apart sufficiently to allow passage of the ferrules 18. One pin of each pin pair axially extending from either end of the fluorescent lamp 16 is then inserted laterally into one of the arcuate slots 54 in each of the sockets 14 until that pin engages the electrical contact of its corresponding socket slot. The fluorescent lamp 16 is then rotated around an imaginary axis extending along the first-engaged pin of each pin pair such that the remaining pin of each pin pair is rotated around the engaged pin through the remaining one of the arcuate slots 54 in each of the sockets 14 until the remaining pin of each pin pair engages the electrical contact in the remaining slot of each socket 14.

Where devices 10″ constructed according to the third embodiment are employed, the step of causing the ends of the lamp 16 to engage the fluorescent lamp retaining devices 10 includes positioning ferrules 18 of the fluorescent lamp 16 against the lower lamp-receiving gap 68 of the fluorescent lamp retaining devices 10″; then pushing the ferrules 18 through the lower lamp-receiving gap 68 such that the lowermost two lamp-holder fingers 66 are spread apart sufficiently to allow passage of the ferrules 18 into the semi-circular finger opening 70.

The procedure for removing a fluorescent lamp from a fluorescent lamp fixture 12 that includes fluorescent lamp retainer devices 10 constructed and installed according to the invention, is a straight-forward reversal of the installation procedure.

The design of the fluorescent lamp retaining device 10 is such that an installer can install a fluorescent lamp 16 in a fixture 12 by using the same procedure of inserting the lamp laterally into the fixture 12, and engaging the pin pairs at opposite ends of a fluorescent tube in respective socket 14 receptacles. In so doing, the fluorescent lamp retaining device 10 automatically receives the fluorescent lamp 16 into engagement. An installer can therefore install a fluorescent tube in exactly the same manner as if the fluorescent lamp retaining device 10 were not installed. No separate actuation or engagement step is required. Likewise, when removing a fluorescent lamp 16 from a fixture 12 including the fluorescent lamp retaining device 10, the device 10 releases the lamp 16 as the lamp is removed from its sockets 14 in the same manner as if the fluorescent lamp retaining device 10 were not installed. The only difference that an installer would notice upon installation and removal is that a slightly greater amount of pressure is required to both insert and remove a lamp 16 from a fixture 12 including fluorescent lamp retaining devices 10 constructed according to the invention.

This description is intended to illustrate certain embodiments of the invention rather than to limit the invention. Therefore, it uses descriptive rather than limiting words. Obviously, it's possible to modify this invention from what the description teaches. Within the scope of the claims, one may practice the invention other than as described.

1. A fluorescent lamp retaining device for releasably retaining a fluorescent lamp in a light fixture, the device comprising:
a mount configured to be carried by a fluorescent lamp socket of the type that receives and provides electrical contact with a pin pair axially extending from a fluorescent lamp end; and
a lamp holder carried by the mount and disposed in a position to releasably engage a fluorescent lamp end having an axially-extending pin pair engaged in a lamp socket carrying the mount, the lamp holder being configured to laterally receive such a lamp end as the lamp is being installed and as the pin pair axially extending from that lamp end is being received into the lamp socket carrying the mount.

2. A fluorescent lamp retaining device as defined in claim 1 in which the lamp holder includes a resilient circlip.

3. A fluorescent lamp retaining device as defined in claim 2 in which the circlip includes two circlip ribs configured to be forced apart when a fluorescent lamp is inserted between them and to releasably retain the lamp once the lamp has been fully inserted between the ribs.

4. A fluorescent lamp retaining device as defined in claim 3 in which distal ends of the two ribs are curved radially outward to form respective camming surfaces positioned to force the ribs apart when a fluorescent tube is forced laterally between the distal ends of the circlip ribs.

5. A fluorescent lamp retaining device as defined in claim 1 in which the lamp holder is configured to laterally receive a ferrule disposed at an end of a fluorescent lamp into engagement simultaneous with the socket receiving a pin pair axially extending from that end of the lamp.

6. A fluorescent lamp retaining device as defined in claim 1 in which the mount includes a pair of mounting ribs configured to engage a fluorescent lamp socket by wrapping around a radially outer wall of such a socket.

7. A fluorescent lamp retaining device as defined in claim 1 in which:
the fluorescent lamp retaining device includes a spine that extends axially forward from an upper mid region of the mount;
the lamp holder is supported on a forward distal end of the spine; and
the mount, spine, and lamp holder are formed together as a single, unitary piece.

8. A fluorescent lamp retaining device as defined in claim 1 in which the mount comprises a support ring supportable axially adjacent the fluorescent lamp socket and including a central axial opening shaped accomodate a fluorescent lamp socket and a lower radial pin channel shaped to allow electrical contact pins of the fluorescent lamp end to be laterally received into the axial opening of the support ring and into a lamp socket carried by the support ring.

9. A fluorescent lamp retaining device as defined in claim 8 in which the lamp holder includes a plurality of resilient lamp holder fingers that extend radially inwardly from around the support ring and are configured such that the fingers are forced to splay apart when a fluorescent lamp is inserted between them and to releasably retain the lamp once the lamp has been fully inserted between the fingers.

10. A fluorescent lamp retaining device as defined in claim 9 in which the lamp holder fingers are disposed in an array that includes a lower lamp-receiving gap between two lower-most fingers that is slightly narrower than a diameter of a fluorescent tube to be supported and slightly narrower than a diameter of a semi-circular finger opening formed by the distal ends of the lamp holder fingers.

11. A fluorescent lamp retaining device as defined in claim 10 in which the lamp-receiving gap is shaped to allow a fluorescent lamp to be pushed laterally or radially into the semi-circular axial finger opening from a position radially displaced from the fluorescent lamp retaining device, forcing the fingers to splay apart sufficiently to accommodate the lateral insertion of a lamp.

12. A fluorescent lamp retaining device for releasably retaining a fluorescent lamp in a light fixture, the device comprising:
a fluorescent lamp socket configured to receive and provide electrical contact with a pin pair axially extending from one end of a fluorescent lamp;
a mount carried by the fluorescent lamp socket; and
a lamp holder carried by the mount and disposed in a position to releasably engage a fluorescent lamp end having an axially-extending pin pair engaged in the lamp socket, the lamp holder being configured to laterally receive such a lamp end as the lamp is being installed and as the pin pair axially extending from that lamp end is being received into the lamp socket.

13. A fluorescent lamp retaining device as defined in claim 12 in which the lamp socket is configured to receive an axially extending pair of pins of a fluorescent lamp through rotating engagement.

14. A fluorescent lamp retaining device as defined in claim 13 in which:
the lamp socket includes a pair of arcuate slots, a first one of which is configured to laterally receive a first one of the pins of an axially-extending pin pair of a fluorescent lamp into engagement with a first electrical contact and a second one of which is configured to then laterally receive a second pin of the pin pair by rotating the fluorescent tube about the first pin such that the second pin travels around an arcuate path through the second slot into engagement with a second electrical contact; and
the mount is configured to engage such a fluorescent lamp as a first pin of an axially-extending pin pair of the lamp is laterally inserted into the first slot of the pair of arcuate slots, and to accommodate the motion of the fluorescent lamp as it is rotated about the first pin until a second pin of the pin pair is received into the electrical contact of the second arcuate slot.

15. A method for releasably retaining a fluorescent lamp in a light fixture, the method including the steps of:
mounting first and second fluorescent lamp retaining devices on respective first and second fluorescent lamp sockets;
installing the first and second fluorescent lamp sockets in axially opposite positions in a fluorescent lamp fixture; and
installing a fluorescent lamp in the light fixture by plugging the lamp into the lamp sockets and causing the lamp to engage the first and second fluorescent lamp retaining devices.

16. The method of claim 15 in which the step of mounting first and second fluorescent lamp retaining devices includes inserting the first and second fluorescent lamp sockets between mounting ribs of the first and second fluorescent lamp retaining devices, respectively, until mounting tabs of the first and second fluorescent lamp retaining devices engage fastener-head receiving recesses of the first and second lamp sockets.

17. The method of claim 15 in which the step of installing a fluorescent lamp includes:
positioning first and second ferrules of a fluorescent lamp against cam surfaces formed by out-turned distal ends of circlip ribs of the first and second fluorescent lamp retaining devices, respectively; and
pushing the ferrules between the distal ends of the circlip ribs such that the circlip ribs are spread apart to allow passage of the ferrules.

18. The method of claim 15 in which the step of installing a fluorescent lamp includes:
directing a first pin of each of two pin pairs axially extending from respective opposite ends of the fluorescent lamp into a first one of two arcuate slots in each of the sockets until those pins engage the electrical contacts in those slots; and
rotating the fluorescent lamp around an imaginary longitudinal axis extending between the two engaged pins such that a second pin of each pin pair is rotated through a second one of the arcuate slots in each of the sockets until the second pin of each pin pair engages the electrical contacts in those slots.
